(19) United States
(12) Patent Application Publication
(10) Pub. No.: US 2008/0091514 A1
(43) Pub. Date: Apr. 17, 2008

(54) Determining an Executable Growth Strategy

(75) Inventors: James Shu-wei Fung, Ontario (CA); Leo G. Marland, Toronto (CA)

Correspondence Address: BOND SCHOENECK & KING, PLLC, ONE LINCOLN CENTER, SYRACUSE, NY, 13202, US

(73) Assignee: INTERNATIONAL BUSINESS MACHINES CORPORATION, Armonk, NY (US)

(21) Appl. No.: 11/869,272

(22) Filed: Oct. 9, 2007

(30) Foreign Application Priority Data
Oct. 17, 2006 (CA) CA2564451

(51) Int. Cl. G06F 17/30

(52) U.S. Cl. 705/10; 705/7

(57) ABSTRACT

A method, system and computer readable medium embodying computer executable modules for determining an executable growth strategy for a company by proactively identifying and evaluating specific unsolicited business propositions for the company according to criteria. The criteria include how well the business propositions address issues of targeted prospects and how well the business propositions leverage the company's blend or blends of capabilities that confer on the company a competitive advantage.

### PRIORITY CLAIM

The present application claims priority to Canadian Patent Application No. CA2564451, filed Oct. 17, 2006, the entirety of which is hereby incorporated by reference.

### COPYRIGHT NOTICE

A portion of the disclosure of this patent document contains material which is subject to copyright protection. The copyright owner has no objection to the facsimile reproduction of the patent document or the patent disclosure, as it appears in the Patent and Trademark Office patent file or records, but otherwise reserves all copyright rights whatsoever.

### TECHNICAL FIELD

The invention is related to business strategy consulting. More specifically, the invention is related to the identification and evaluation of business propositions and planning actions.

### BACKGROUND

Companies are always seeking to grow, and business strategies are often used to set directions for executable actions. The conventional path is to employ traditional methods such as Porter's Five Forces, financial analysis, and third-party generic research. Based on the results of these methods, the company then determines at a high level on what areas to focus, using models such as the GE/McKinsey Market Attractiveness versus Competitive Portfolio Analysis, the Boston Consulting Group (BCG) share matrix, or other models. A task force and teams are put in place to further develop specific actions and to identify concrete propositions to pursue. Some will also review their own strengths and select an area to concentrate on.

As competition increases, both in intensity from traditional competitors and in new competition from non-traditional players, there is a need to aggressively pursue the right kinds of prospects. Senior management of companies has a significant need to be able to proactively identify worthwhile pursuits and to pursue them in an unsolicited manner. However, conducting high level strategies does not point to concrete propositions or specific clients that can be pursued.

At a lower level, companies may react to individual propositions as they surface and may evaluate them on an ad-hoc basis to determine whether it is worthwhile to pursue them.

### SUMMARY

An executable growth strategy for a company is one that the company can actually execute. It identifies concrete actions that the company can take, rather than just high level goals. The strategy may be determined by proactively identifying specific worthwhile business propositions and pursuing them in an unsolicited manner. To accomplish this, one may compare capabilities of the company to those of its competitors to identify one or more blends or combinations of capabilities of the company which confer on the company a competitive advantage. The blends may be unique to the company. One may also identify targeted prospects, by analyzing gathered data about sectors of industry, particular prospects in those sectors, and issues of concern to those prospects. Specific unsolicited business propositions may then be evaluated according to criteria, where the criteria includes how well a proposition leverages one or more of the blends and how well a proposition addresses issues that are relevant for one or more of the targeted prospects. The criteria may include key criteria, and the specific unsolicited business propositions may be prioritized according to their evaluation with respect to the key criteria.

### BRIEF DESCRIPTION OF THE DRAWINGS

Embodiments are illustrated by way of example and not limitation in the figures of the accompanying drawings, in which like reference numerals indicate corresponding, analogous or similar elements, and in which:

FIG. 1 is a flowchart of an exemplary method for determining an executable growth strategy for a company;

FIG. 2 is a sample chart of pairings of various industries and exemplary issues experienced by organizations in those industries;

FIG. 3 is a block diagram of an exemplary business strategy management system; and

FIG. 4 is a block diagram of an exemplary computing environment in which to implement the method of FIG. 1 and the system of FIG. 3.

It will be appreciated that for simplicity and clarity of illustration, elements shown in the figures have not necessarily been drawn to scale. For example, the dimensions of some of the elements may be exaggerated relative to other elements for clarity.

### DETAILED DESCRIPTION

In the following detailed description, numerous specific details are set forth in order to provide a thorough understanding of embodiments. However it will be understood by those of ordinary skill in the art that the embodiments may be practiced without these specific details. In other instances, well-known methods, procedures, components and circuits have not been described in detail so as not to obscure the embodiments.

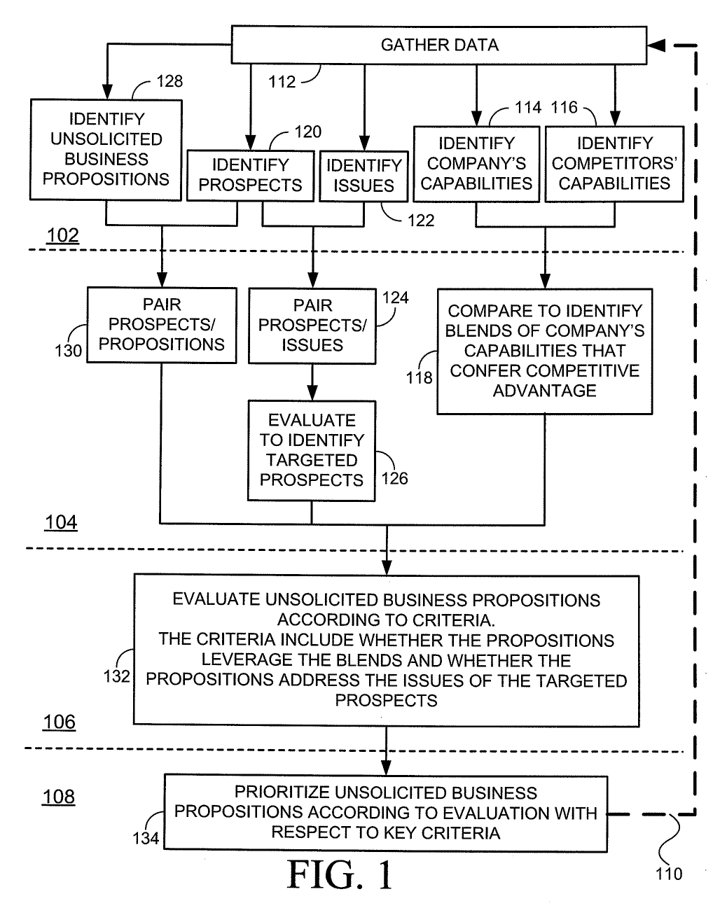

FIG. 1 is a flowchart of an exemplary method for determining an executable growth strategy. Four stages of the method are shown. At a first stage 102, data gathered from various sources is compiled to identify components used in the following analysis. At a second stage 104, initial pairings or comparisons of the components are made. At a third stage 106, unsolicited business propositions are evaluated according to criteria. Some of the criteria are dependent on the results of the second stage. At a fourth, optional, stage 108, the unsolicited business propositions are prioritized according to their evaluation with respect to key criteria. As indicated by a dashed arrow 110, the process may be iterative.

In more detail, first stage 102 comprises gathering data at 112 from various sources. This data may be compiled and analyzed to identify the company's capabilities at 114, and the capabilities of the company's competitors at 116. For example, the data compiled and analyzed to identify the company's capabilities may be obtained from sources such as annual reports, structure and the company's intranet. The data compiled and analyzed to identify the capabilities of the company's competitors may be obtained, for example, from sources such as annual reports, the competitors' websites, and internal and customer feedback. Data gathered for the company and its competitors may include, for example, financial information, ratios, and management discussion; functional structure, reporting, locations, competencies, solutions and offerings, research plans and projects.

The following table is a sample compilation of a particular company's capabilities. This is just an example, and other capabilities and categorizations are also contemplated.

| General Capability | Sub-category | Specific Capability |
|---|---|---|
| Ability to create, develop, | [symbol] | Fundamental research |
| and manufacture technologies | [symbol] | Applied research |
| | | Industry-specific research |
| | | Manage intellectual property |
| | Bringing products to market | Design and Development - IPD |
| | | Manufacturing |
| | | Delivery and Logistics |
| | | Integrated Supply Chain (ISC) |
| Ability to translate | Assembling the optimal mix of | Manage breadth of solutions |
| technologies into business | offerings to design tailored solutions | Individualization |
| value through solutions and | Selling hardware, software and | Privileged relationship/access |
| services worldwide | services | Industry processes |
| | | [symbol] |
| | Realizing solutions and providing | Consulting |
| | support | Technical design and implementation |
| | | [symbol] |
| | | [symbol] |
| | | [symbol] |
| | Outsourcing | Financial stability and strength |
| | | Process efficiency |
| Ability to help customers | [symbol] | Financial strength and offerings |
| who want to finance their | | Financing |
| purchase | | |
| Ability to operate globally | Managing geographically and | Understand local environment |
| | culturally diverse resources | Establish and maintain policies worldwide |
| | | Leverage resources worldwide |
| | | [symbol] |
| | Establishing and maintaining | |
| | relationships with government | |

The company's capabilities and those of its competitors may be compared at 118 to identify one or more blends of the company's capabilities that confer a competitive advantage. One or more of the blends may be unique to the company.

In the sample table given above, certain capabilities are highlighted by bold italic font to indicate that they form a blend of the company's capabilities that confers a competitive advantage. A highlighted sub-category means that the entire range of capabilities in that sub-category is included in the blend. Based on a comparison of the company's capabilities with those of its competitors, this sample blend consists of research and development, partnering, end-to-end capable, provide field support, finance position and off-shore capabilities.

The following table shows the results of a sample comparison of the company with its competitors, labeled A-J. A “Y” indicates that the competitor has the specific capability. A “p” indicates that the competitor has a partial ability to provide the specific capability. A blank space indicates that the competitor lacks the specific capability.

| Sub-category | Specific Capability | A | B | C | D | E | F | G | H | I | J |
|---|---|---|---|---|---|---|---|---|---|---|---|
| Research and | Fundamental research | Y | p | p | | | | | | | |
| Development | Applied research | p | p | p | | | | | | p | p |
| | Industry-specific research | Y | Y | Y | Y | p | Y | Y | p | | p |
| | Manage intellectual property | p | p | p | p | p | p | p | p | p | p |
| Bringing products | Design and Development —IPD | Y | Y | Y | | | | | | Y | p |
| to market | Manufacturing | Y | Y | Y | | | | | | Y | p |
| | Delivery and Logistics | Y | Y | Y | | | | | | Y | p |
| | Integrated Supply Chain (ISC) | Y | Y | Y | | | | | | Y | p |
| Assembling mix of | Manage breadth of solutions | | | | p | | p | | p | | |
| offerings | | | | | | | | | | | |
| Selling hardware, | Privileged relationship/access | Y | Y | Y | Y | Y | Y | Y | Y | Y | Y |
| software and | Industry processes | p | p | p | Y | Y | Y | Y | Y | p | Y |
| services | [symbol] | | Y | | Y | | | Y | p | | p |
| Realizing solutions | Consulting | | | | Y | | Y | Y | Y | | p |
| and providing | Technical design and implementation | | | | | | | | | | |
| support | [symbol] | p | | | p | | | | Y | | |
| | [symbol] | p | p | p | Y | | p | | p | p | |
| Outsourcing | Financial stability and strength | p | Y | p | p | | | | | p | p |
| Finance Position | Financial strength and offerings | p | Y | p | p | | | | | p | |
| | Financing | p | p | p | p | | p | | | | |
| Managing | Understand local environment | Y | Y | Y | Y | | p | Y | Y | p | Y |
| geographically and | Establish and maintain policies | Y | Y | Y | Y | | p | Y | Y | Y | Y |
| culturally diverse | worldwide | | | | | | | | | | |
| resources | Leverage resources worldwide | Y | p | p | Y | | p | Y | Y | Y | Y |
| | [symbol] | Y | Y | p | Y | | p | Y | Y | | p |

The data gathered at 112 may also be compiled and analyzed to identify prospects at 120, and to identify issues at 122. The data may be gathered, for example, from sector databases, industry play books and other suitable sources of information.

The prospects may be identified by sector and industry. For example, a particular airline and a particular bus company may be identified as prospects in the travel and transportation industry. In another example, two particular banks and one credit union may be identified as prospects in the banking industry.

For example, the issues, also known as “pain points”, may be classified into broad categories. For each category, specific issues may be identified and described in detail, both at a general level and specific to a particular sector or industry.

For example, “increasing branch effectiveness” is a specific issue about increasing revenue through branch sales. In general, there is difficulty in having a common view of a customer across the organization, and branch staff having the knowledge and skills to make the sales. Specifically in the banking industry, banks are grappling with how to drive new high value, non-transactional businesses through the branches, with staff having limited knowledge across products, understanding of customers and their turnover limits sustained relationships.

In another example, “relationship with retailers” is a specific issue about striking a win-win relationship with the retailers. In general, there is difficulty in managing such a relationship when the power has tipped toward the retailers through their branding, size and scale. Specifically in the consumer packaging goods (CPG) industry, companies are having difficulties managing the retailers. The distribution model relies heavily on retailers. With increasing size and scale of retailers, and their own branding, CPG companies are being relegated to being led by retailers.

In yet another example, “saturated market” is a specific issue about increasing revenue despite a saturated market that limits growth. In general, the difficulty is in finding ways to increase a customer base in an already penetrated market, or to increase customer spending without cannibalizing existing products. Specifically in the telecom industry, fixed line business is saturated and mobile customers are moving quickly toward saturation. Specifically in the movies and entertainment industry, traditional segments have already reached their limits. At the same time, customers are allocating the same spending over a dramatic increase in content.

Likewise, descriptions may be given for other issues.

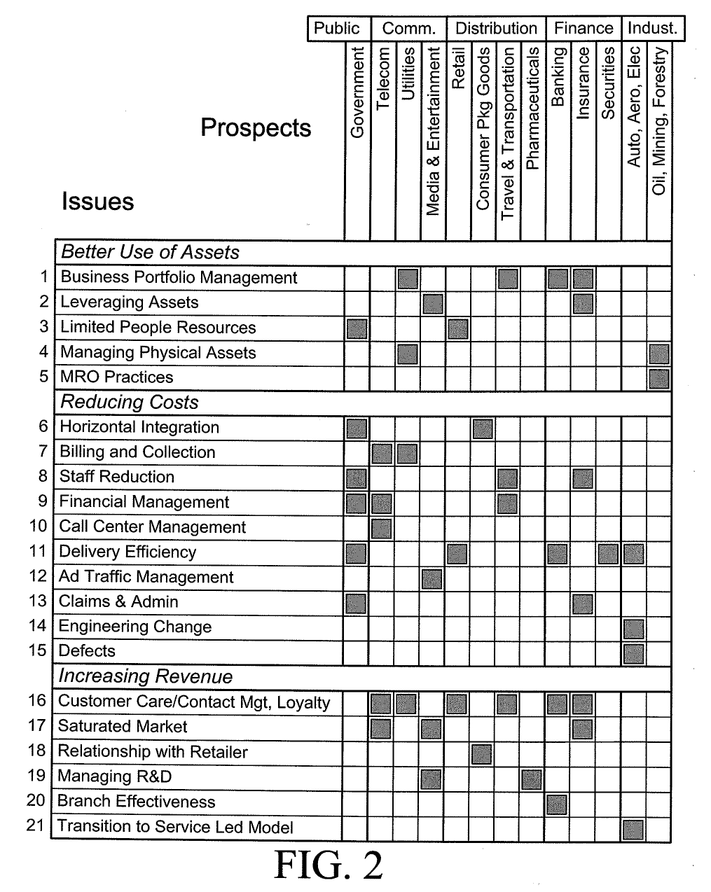

Once the prospects and issues have been identified, they may be paired at 124 to determine which issues are relevant for which of the prospects. FIG. 2 is a sample chart of pairings of various industries and exemplary issues experienced by organizations in those industries. Twenty-one issues have been listed, belonging to three general categories: better use of assets, reducing costs, and increasing revenue. This is just an example, and different issues and categories are also contemplated.

Filled boxes in the chart indicate issues of concern, or pain points, of prospects belonging to the listed industries and sectors. For example, in the sample chart, maintenance, repair and overhaul (MRO) practices are relevant to the oil, mining and forestry industries, but not to the financial sector. Likewise, saturated market is relevant to telecom, insurance, and media and entertainment, but may not be to the public sector.

Returning to FIG. 1, the prospects may be evaluated at 126 according to criteria to identify targeted prospects. Prospects may be filtered at this stage according to the results of the evaluation.

The following table shows the results of a sample evaluation, according to various criteria, of certain prospects that are labeled 1-16. An “L” indicates that the specific criterion is likely to be satisfied by the prospect. An “S” indicates that the specific criterion is somewhat likely to be satisfied by the prospect. A “U” indicates that the specific criterion is unlikely to be satisfied by the prospect. The criteria listed here are just examples, and different criteria are also contemplated.

| | | | | Media & | | | | | | | | | | | |
|---|---|---|---|---|---|---|---|---|---|---|---|---|---|---|---|
| | Telecom | | | Ent | | | Utilities | | | Public | | Insurance | | | |
| Criteria | 1 | 2 | 3 | 4 | 5 | 6 | 7 | 8 | 9 | 10 | 11 | 12 | 13 | 14 | 15 |
| Has burning issues | L | L | L | S | S | S | L | L | L | L | L | L | L | L | L |
| Has urgency for transformation | L | L | L | U | U | L | S | L | L | L | S | L | S | L | S |
| Has financial stability/ability to | L | S | S | L | L | L | L | L | S | L | L | L | L | L | S |
| fund transformation | | | | | | | | | | | | | | | |
| Regarded as an industry leader | L | S | L | S | U | L | U | S | L | U | U | L | L | L | S |
| Has likelihood for high | U | S | S | U | S | L | L | L | U | L | L | S | S | L | S |
| spending in coming year | | | | | | | | | | | | | | | |
| Has strong relationship with | L | U | U | U | U | U | S | L | L | S | S | S | L | L | S |
| company | | | | | | | | | | | | | | | |
| Strategic account to win | L | L | L | L | L | L | L | L | S | L | S | L | L | L | L |
| back/develop relationship with | | | | | | | | | | | | | | | |
| Has key issues applicable to | S | S | S | U | U | U | L | L | L | S | S | S | S | S | S |
| other sectors | | | | | | | | | | | | | | | |

For example, if a prospect has key issues that are applicable to other sectors, then this prospect may be attractive to the company because if a solution is found for this prospect, the solution may be replicable for others. However, if a different prospect has a lot of money to spend and it will be prestigious for the company to work with this prospect, then even if the issues of that prospect are not shared with others, the prospect may still be attractive.

The data gathered at 112 may also be compiled and analyzed to identify specific business propositions at 128. These specific business propositions are identified, for example, from either a company's known large scale solution, or its understanding of a solution to a significant and/or complex area that a client or client industry is facing but no commonly known solution is available.

Once the prospects and propositions have been identified, they may be paired at 130 to determine which propositions are relevant for which of the prospects.

The following table shows an exemplary portion of the prospect-proposition pairs. This pairing is just an example, and other pairings are also contemplated. An “X” indicates that the particular proposition is relevant for that prospect. The company may have many more business propositions than those listed in the table below. The business propositions listed here are just examples, and other business propositions are contemplated.

| | | | | Media & | | | | | | | | | | | |
|---|---|---|---|---|---|---|---|---|---|---|---|---|---|---|---|
| | Telecom | | | Ent | | | Utilities | | | Public | | Insurance | | | |
| Business Proposition | 1 | 2 | 3 | 4 | 5 | 6 | 7 | 8 | 9 | 10 | 11 | 12 | 13 | 14 | 15 |
| Billing & Cash Collection BTO | X | X | X | | | | | | | | | | | | |
| Contact Centre Consolidation | X | | X | | | | | | | | | | | | |
| M&A Assistance | | | | | | | | | | | | X | X | X | |
| Revenue Assurance | X | X | X | | | | | | | | | | | | |
| Asset Management Solution | | | | | | | X | X | X | | | | | | |
| Next Wave Customer Care | X | X | X | | | | | | | | | | | | |
| AMS for applications insurers | | | | | | | | | | | | | | X | X |
| want to sunset | | | | | | | | | | | | | | | |
| Ad Traffic Management | | | | X | | X | | | | | | | | | |
| Data Analytics | X | X | X | | | | | | | | | | | | |
| Pension Outsourcing | | | | | | | | | | | X | | | | |
| Digital Factory | | | | X | X | X | | | | | | | | | |

For example, billing and cash collection built-to-order (BTO) is relevant to prospects 1, 2 and 3, but contact centre consolidation is relevant only to prospects 1 and 3, even though all three prospects belong to the same sector, telecom. In another example, mergers and acquisitions (M&A) assistance is relevant to three of the four prospects belonging to the insurance sector. In yet another example, an applications management services (AMS) to handle applications that the insurers want to sunset is relevant only to two of the prospects belonging to the insurance sector.

At 132, the unsolicited business propositions are evaluated according to criteria. The criteria include whether the propositions leverage the blends and whether the propositions address the issues of the targeted prospects.

For example, the criteria may be categorized into three groups: those that are compelling to the customer, those that are compelling to the company, and those that are related to a competitive position.

The following three tables show the results of a sample evaluation, according to criteria that are compelling to the customer, compelling to the company, and are related to a competitive position, respectively. An “L” indicates that the specific criterion is likely to be satisfied by the proposition. An “S” indicates that the specific criterion is somewhat likely to be satisfied by the proposition. A “U” indicates that the specific criterion is unlikely to be satisfied by the proposition. The criteria and business propositions listed here are just examples, and different criteria and propositions are also contemplated. The key criteria are highlighted in the tables by bold italic font.

| | Compelling to customer | | | | | | |
|---|---|---|---|---|---|---|---|
| | Addresses | | | | | | |
| | CEO | [symbol] | Simplifies | Geographically | Variable cost | [symbol] | Credible |
| Business Proposition | agenda | [symbol] | business | applicable | structure | [symbol] | Skills |
| Billing & Cash Collection BTO | L | [symbol] | L | S | S | [symbol] | S |
| Contact Centre Consolidation | L | [symbol] | L | U | S | [symbol] | L |
| M&A Assistance | L | [symbol] | L | S | U | [symbol] | S |
| Revenue Assurance | S | [symbol] | S | S | S | [symbol] | S |
| Asset Management Solution | S | [symbol] | L | L | U | [symbol] | U |
| Next Wave Customer Care | L | [symbol] | S | L | S | [symbol] | S |
| AMS for applications insurers | L | [symbol] | L | L | S | [symbol] | L |
| want to sunset | | | | | | | |
| Ad Traffic Management | S | [symbol] | L | L | U | [symbol] | U |
| Data Analytics | S | [symbol] | S | L | U | [symbol] | S |
| Pension Outsourcing | S | [symbol] | L | L | L | [symbol] | S |
| Digital Factory | L | [symbol] | L | L | L | [symbol] | L |

| | Compelling to company | | | | | |
|---|---|---|---|---|---|---|
| | [symbol] | | | Past | | Value |
| | [symbol] | | | implementation | Scope well | easily |
| Business Proposition | [symbol] | Leverageable | Repeatable | successful | defined | accepted |
| Billing & Cash Collection BTO | [symbol] | L | L | S | S | L |
| Contact Centre Consolidation | [symbol] | L | S | L | S | L |
| M&A Assistance | [symbol] | L | S | L | U | S |
| Revenue Assurance | [symbol] | U | L | S | L | L |
| Asset Management Solution | [symbol] | S | L | U | S | S |
| Next Wave Customer Care | [symbol] | S | L | S | U | S |
| AMS for applications insurers | [symbol] | U | L | L | S | L |
| want to sunset | | | | | | |
| Ad Traffic Management | [symbol] | U | L | U | L | L |
| Data Analytics | [symbol] | S | S | S | U | S |
| Pension Outsourcing | [symbol] | S | L | U | L | S |
| Digital Factory | [symbol] | S | L | S | S | L |

| | Competitive position | | | |
|---|---|---|---|---|
| | | | [symbol] | Company |
| | Thought | | [symbol] | as a |
| Business Proposition | leadership | Innovative | [symbol] | supplier |
| Billing & Cash Collection BTO | U | L | [symbol] | L |
| Contact Centre Consolidation | U | U | [symbol] | L |
| M&A Assistance | S | U | [symbol] | L |
| Revenue Assurance | L | U | [symbol] | L |
| Asset Management Solution | S | S | [symbol] | L |
| Next Wave Customer Care | L | L | [symbol] | L |
| AMS for applications insurers | U | U | [symbol] | L |
| want to sunset | | | | |
| Ad Traffic Management | L | L | [symbol] | L |
| Data Analytics | L | L | [symbol] | L |
| Pension Outsourcing | U | S | [symbol] | L |
| Digital Factory | L | L | [symbol] | L |

At 134, the business propositions may be prioritized according to their evaluation with respect to the key criteria. The following table shows the score for each of the business propositions with respect to the key criteria, and with respect to the other criteria. For example, revenue assurance scored three “somewhat likely” scores with respect to the four key criteria.

| | With respect to | | | With respect to | | |
|---|---|---|---|---|---|---|
| | 4 key criteria | | | other 13 criteria | | |
| | | Somewhat | | | Somewhat | |
| Business Proposition | Likely | Likely | Unlikely | Likely | Likely | Unlikely |
| Billing & Cash Collection BTO | 2 | 2 | 0 | 6 | 6 | 1 |
| Contact Centre Consolidation | 3 | 1 | 0 | 7 | 3 | 3 |
| M&A Assistance | 4 | 0 | 0 | 5 | 5 | 3 |
| Revenue Assurance | 0 | 3 | 1 | 5 | 6 | 2 |
| Asset Management Solution | 0 | 4 | 0 | 4 | 6 | 3 |
| Next Wave Customer Care | 2 | 2 | 0 | 6 | 6 | 1 |
| AMS for applications insurers | 1 | 0 | 3 | 7 | 2 | 4 |
| want to sunset | | | | | | |
| Ad Traffic Management | 0 | 2 | 2 | 8 | 1 | 4 |
| Data Analytics | 1 | 2 | 1 | 5 | 6 | 2 |
| Pension Outsourcing | 2 | 2 | 0 | 7 | 4 | 2 |
| Digital Factory | 4 | 0 | 0 | 10 | 3 | 0 |

There are many different ways to prioritize the business propositions. For example, propositions may be prioritized first according to the number of “likely” evaluations with respect to the four key criteria, and then according to a weighted sum of the “likely” and “somewhat likely” evaluations with respect to the other criteria. Any weighted combination of the evaluations may be used to prioritize the business propositions. For example, each proposition may be weighted based on its importance or likely impact, thus prioritizing the proposition at the root level.

In this example, propositions having three or four “likely” evaluations with respect to the four key criteria are assigned to a “high” priority, those having two are assigned to a “middle” priority, and the rest are assigned to a “low” priority. Accordingly, the Contact Centre Consolidation, M&A Assistance and Digital Factory propositions are assigned high priority; the Billing & Cash Collection BTO, Pension Outsourcing and Next Wave Customer Care propositions are assigned medium priority; and the other business propositions listed above are assigned low priority.

The company may use the output of this method to determine which specific unsolicited business opportunities to pursue, with the understanding that they have been selected on the basis of a rigorous quantitative analysis.

This method may be implemented in software, and systems to enable users to analyze the method may be developed using known software techniques. The software may be run in any suitable computer system, including a distributed computer system. The software may be stored on computer-readable media in the form of computer-executable instructions or data structures. Such computer-readable media can be any available media that can be accessed by a general-purpose or special-purpose computer. By way of example, and not limitation, such computer-readable media may comprise physical computer-readable media such as RAM, ROM, EEPROM, flash memory or other memory technology, CD-ROM, DVD or other optical disk storage, magnetic disk storage or other magnetic storage devices, or any other medium which can be used to carry or stored desired program code means in the form of computer-executable instructions or data structures and which can be accessed by a general-purpose or special purpose computer.

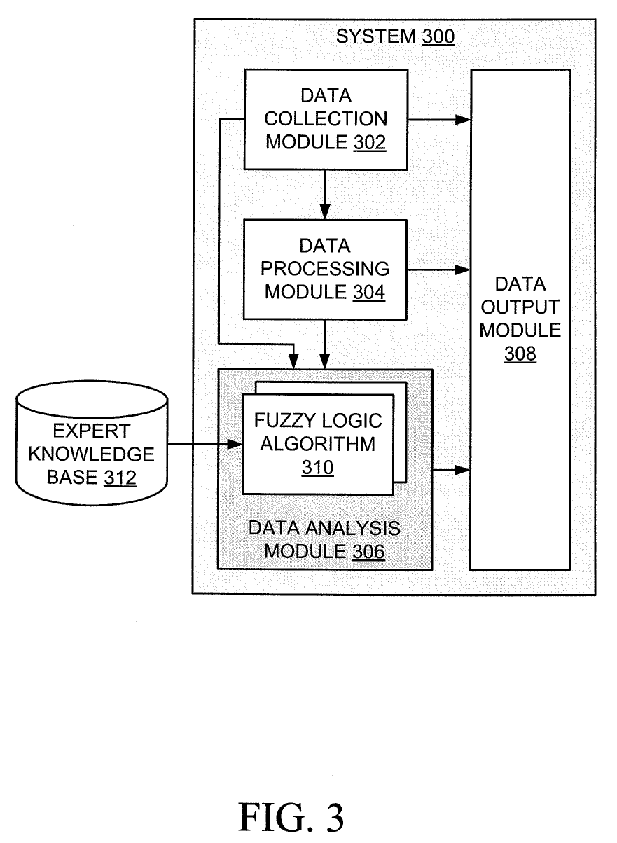

FIG. 3 is a block diagram of an exemplary business strategy management system. A system 300 comprises a data collection module 302, a data processing module 304, a data analysis module 306 and a data output module 308. Data collection module 302 enables the gathering and collection of data. For example, information on targeted prospects, information about the company and its competitors, issues of the prospects or the industry or sector of the prospects, and specific unsolicited business propositions are gathered by data collection module 302.

Data processing module 304 processes the data gathered by data collection module 302. For example, information about prospects and issues identified by module 302 may be processed to output attributes based on criteria. These attributes may include attributes of the prospects/issues pairing, including rating of relevance and/or alignment (e.g. high/medium/low or by percentage), the prospect as an enterprise or a division within an enterprise, the impact of the issues, the applicability of the issues to a company and/or an industry, and the like. In another example, information about the company and its competitors identified by module 302 may be compared to identify one or more blends of capabilities of the company that confer on the company a competitive advantage.

Data analysis module 306 analyzes the output of data collection module 302 and/or the output of data processing module 304. The analysis may involve, for example, categorizing, filtering and/or scoring according to criteria. For example, data analysis module 306 may apply one or more fuzzy logic algorithms 310 to this output to evaluate and prioritize specific unsolicited business propositions according to criteria. A fuzzy logic algorithm may be derived from an expert knowledge base 312 that may be coupled to or incorporated in system 300.

Data output module 308 is able to cross reference any of the outputs of data collection module 302, data processing module 304 and data analysis module 306 to output pairings of the information. For example, data output module 308 may produce prospect/issue pairings or proposition/prospect pairings. In yet another example, data output module 308 may produce the ranking of the pairings by different means, such as best fit scenario, or best aligned with unique blend of capabilities, based on criteria used in data analysis module 306.

The functionality of the modules described above may be shared and/or distributed among other modules.

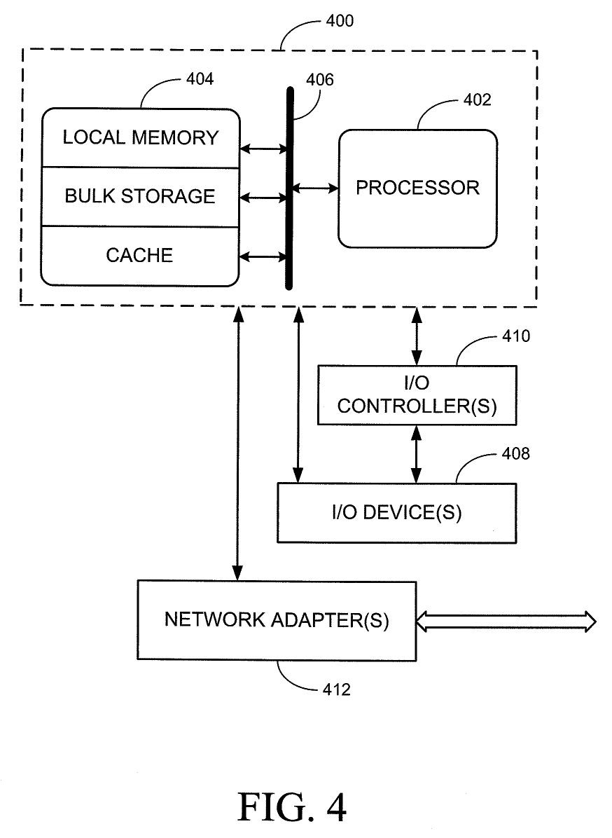

FIG. 4 is a block diagram of an exemplary computing system in which the method of FIG. 1 and the system of FIG. 3 may be implemented.

A computing system 400 suitable for storing and/or executing program code will include at least one processor 402 coupled directly or indirectly to memory elements 404 through a system bus 406. The memory elements 404 can include local memory employed during actual execution of the program code, bulk storage, and cache memories which provide temporary storage of at least some program code in order to reduce the number of times code must be retrieved from bulk storage during execution.

Input/output (I/O) devices 408—including but not limited to keyboards, displays, pointing devices, and the like—can be coupled to data processing system 400 either directly or through intervening I/O controllers 410.

Network adapters 412 may also be coupled to data processing system 400 to enable data processing system 400 to become coupled to other data processing systems or remote printers or storage devices through intervening private or public networks. Modems, cable modem and Ethernet cards are just a few of the currently available types of network adapters.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method for determining an executable growth strategy for a company, the method comprising:
comparing capabilities of the company to those of its competitors to identify one or more blends of capabilities of the company which confer on the company a competitive advantage;
identifying targeted prospects; and
evaluating specific unsolicited business propositions according to criteria,
wherein the criteria comprise how well a proposition leverages one or more of the blends and how well a proposition addresses issues that are relevant for one or more of the targeted prospects.

2. The method of claim 1, wherein the one or more blends are unique to the company.

3. The method of claim 2, further comprising:
prioritizing the specific unsolicited business propositions according to their evaluation with respect to key ones of the criteria.

4. The method of claim 1, further comprising:
prioritizing the specific unsolicited business propositions according to their evaluation with respect to key ones of the criteria.

5. The method of any one of claim 4, wherein identifying the targeted prospects comprises:
gathering information about prospects and issues of at least one of the prospects, an industry and a sector of the prospects;
determining which issues are relevant for which of the prospects to form prospect-issue pairs; and
evaluating the prospects according to criteria related to prospects, issues or both to identify the targeted prospects.

6. The method of any one of claim 1, wherein identifying the targeted prospects comprises:
gathering information about prospects and issues of at least one of the prospects, an industry and a sector of the prospects;
determining which issues are relevant for which of the prospects to form prospect-issue pairs; and
evaluating the prospects according to criteria related to prospects, issues or both to identify the targeted prospects.

7. The method of claim 6, further comprising:
determining which of the specific unsolicited business propositions are relevant for which of the prospects to form prospect-proposition pairs.

8. A computer-readable medium having computer-executable modules modified therein, for determining an executable growth strategy for a company comprising:
a data collection module to collect data about prospects of the company, issues, specific unsolicited business propositions, the company and its competitors;
a data processing module to process data collected by the data collection module and to identify targeted prospects and to identify one or more blends of capabilities of the company which confer on the company a competitive advantage; and
a data analysis module to analyze the output of the data collection module and to evaluate the specific unsolicited business propositions according to criteria, wherein the criteria comprise how well a proposition leverages one or more of the blends and how well a proposition addresses issues that are relevant for one or more of the targeted prospects.

9. The computer-readable medium of claim 8, wherein the data analysis module applies one or more fuzzy logic algorithms to the output of at least one of the data collection module and the data processing module.

10. The computer-readable medium of claim 9, wherein at least one of the fuzzy logic algorithms is derived from an expert knowledge base.

11. The computer-readable medium of claim 8, further comprising:
a data output module to cross-reference output of any of the data collection module, the data processing module and the data analysis module to produce pairings including prospect/issue pairs and proposition/prospect pairs.

12. A business strategy management system for determining an executable growth strategy for a company, comprising:
means for collecting data about prospects of the company, issues, specific unsolicited business propositions, the company and its competitors;
means for processing the data to identify targeted prospects and to identify one or more blends of capabilities of the company which confer on the company a competitive advantage; and
means for evaluating the specific unsolicited business propositions according to criteria, wherein the criteria comprise how well a proposition leverages one or more of the blends and how well a proposition addresses issues that are relevant for one or more of the targeted prospects.

13. The system of claim 12, further comprising:
means for producing pairings including prospect/issue pairs and proposition/prospect pairs.

14. The system of claim 13, wherein the means for evaluating comprises:
means for applying one or more fuzzy logic algorithms to output from of at least one of the means for processing data and the means for collecting data.

15. The system of claim 12, wherein the means for evaluating comprises:
means for applying one or more fuzzy logic algorithms to output from of at least one of the means for processing data and the means for collecting data.

16. The system of claim 15, wherein at least one of the fuzzy logic algorithms is derived from an expert knowledge base.
